(19) United States
(12) Patent Application Publication
(10) Pub. No.: US 2016/0267410 A1
(43) Pub. Date: Sep. 15, 2016

(54) CREATING SUSTAINABLE INNOVATION PLATFORMS BASED ON SERVICE FIRST AND SERVICE NOW APPROACH

(71) Applicant: INTERNATIONAL BUSINESS MACHINES CORPORATION, Armonk, NY (US)

(72) Inventors: Chung-Sheng Li, Scarsdale, NY (US); Colin J. Parris, Austin, TX (US)

(21) Appl. No.: 14/744,212

(22) Filed: Jun. 19, 2015

Related U.S. Application Data
(63) Continuation of application No. 14/656,286, filed on Mar. 12, 2015.

(51) Int. Cl. G06Q 10/06

(52) U.S. Cl. CPC G06Q 10/0637

(57) ABSTRACT

A system and method are provided for establishing a sustainable innovation platform. The system includes an innovation services platform including a set of independent, consumable services. The system further includes an innovation community platform including a set of frameworks for forming an innovation community and supporting interaction between community data and community services. The system also includes a monitoring, data assimilation, and simulation platform for service-related monitoring, monitoring-data model assimilation and model-based, machine-executed, what-if simulation. The system additionally includes a service enhancement and service optimization platform for determining service enhancements and service optimizations based on the model-based, machine-executed, what-if simulation.

### CROSS-REFERENCE TO RELATED APPLICATIONS

This application is a Continuation application of co-pending U.S. patent application Ser. No. 14/656,286 filed on Mar. 12, 2015 incorporated herein by reference in its entirety.

### BACKGROUND

1. Technical Field

The present invention relates generally to information processing and, in particular, to creating sustainable innovation platforms based on the service first and service now approach.

2. Description of the Related Art

Traditionally, innovation process is often based on the waterfall model, which is described as follows: start at the concept creation; followed by proof of concept prototypes; and followed by limited deployment in the real environment, before this innovation is hardened and consumable by the mass market. This innovation cycle is usually very lengthy, and often takes months or even years.

However, not every innovation platform succeeds. Many of the innovation platforms never reach sustainable stage because, for example, the innovation becomes irrelevant by the time it reached the marketplace as the market requirements already shifted, resulting in substantial loss of the investment. Thus, there is a need for creating sustainable innovation platforms.

### SUMMARY

According to an aspect of the present principles, a system is provided for establishing a sustainable innovation platform. The system includes an innovation services platform including a set of independent, consumable services. The system further includes an innovation community platform including a set of frameworks for forming an innovation community and supporting interaction between community data and community services. The system also includes a monitoring, data assimilation, and simulation platform for service-related monitoring, monitoring-data model assimilation and model-based, machine-executed, what-if simulation. The system additionally includes a service enhancement and service optimization platform for determining service enhancements and service optimizations based on the model-based, machine-executed, what-if simulation.

According to another aspect of the present principles, a method is provided for establishing a sustainable innovation platform. The method includes providing, by an innovation services platform, a set of independent, consumable services. The method further includes forming, by an innovation community platform including a set of frameworks, an innovation community and supporting interaction between community data and community services. The method also includes performing, by a monitoring, data assimilation, and simulation platform, service-related monitoring, monitoring-data model assimilation and model-based, machine-executed, what-if simulation. The method additionally includes determining, by a service enhancement and service optimization platform, service enhancements and service optimizations based on the model-based, machine-executed, what-if simulation.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, in accordance with an embodiment of the present principles;

FIG. 2 shows an exemplary system 200 for creating sustainable innovation platforms based on a service first and service now approach, in accordance with an embodiment of the present principles;

FIG. 3 shows an exemplary method 300 for creating sustainable innovation platforms based on a service first and service now approach, in accordance with an embodiment of the present principles;

FIG. 4 shows a method 400 for identifying a set of independent, consumable services and additional services, in accordance with an embodiment of the present principles;

FIG. 5 shows a method 500 for obtaining a set of data and metadata used by the innovation service platform 210, in accordance with an embodiment of the present principles;

FIG. 6 shows a method 600 for performing service-related monitoring, monitoring-data model assimilation, and model-based, machine-executed what-if simulation, in accordance with an embodiment of the present principles;

FIG. 7 shows a method 700 for service enhancement and service optimization, in accordance with an embodiment of the present principles;

FIG. 8 shows an exemplary cloud computing node 810, in accordance with an embodiment of the present principles;

FIG. 9 shows an exemplary cloud computing environment 950, in accordance with an embodiment of the present principles; and

FIG. 10 shows exemplary abstraction model layers, in accordance with an embodiment of the present principles.

### DETAILED DESCRIPTION OF PREFERRED EMBODIMENTS

The present principles are directed to creating sustainable innovation platforms in the context of the increasingly prevalent “as a service” and cloud based environment. In an embodiment, the present principles are directed to creating sustainable innovation platforms based on the service first and service now approach.

In the information technology (IT) environment, innovation is increasingly consumed in the form of “as a service” as opposed to the traditional products as a result of the intention for much more rapid deployment of new capabilities. New services are often built on or composed from existing services. “Innovation platforms”, which include a set of basic services, often emerge where new services are rapidly created on top of these basic services.

One or more embodiments of the present principles can address the challenges often encountered in creating sustainable innovation platforms today. In an embodiment, the present principles provide and/or otherwise involve a framework for analyzing the sufficiency and/or necessity of including various services and data as part of the innovation platform in order for the platform to include linchpin data and attractor services. In an embodiment, the present principles provided and/or otherwise include a framework for identifying, based on the continuous monitoring of the actual usage of the platform, areas of enhancement proactively.

In an embodiment, the present principles provide a method and system for establishing sustainable innovation platforms that include the following elements: base innovation platform services, base innovation platform data; a base innovation platform community; a framework for transforming the traditional solution into a new solution at scale; a platform for comprehensive continuous monitoring, model-based data assimilation, and what-if scenario simulation; and proactive platform enhancement and optimization at scale.

The base innovation platform services include a set of highly consumable “Eigenvector” services that constitute the base platform services. These “Eigenvector” services are independent (or “orthogonal”) to each other and could provide sufficient coverage of the target innovation space (or “span” the innovation space). Additional value added services are composed from these Eigenvector services. These Eigenvector enable combinatorial composition of new innovation, capabilities, and services. The concept of eigenvectors originates in linear algebra. An eigenvector of a linear transformation defines a direction invariant under the transformation. The notion of eigenvector service here in terms of providing sufficient coverage of the innovation space is empirical as opposed through a formal proof.

The base innovation platform data includes a set of “linchpin” data and metadata that are needed by the base platform services, including the “patterns” for composing and configuring the services. The linchpin data can be used to bootstrap the services composed from the Eigenvector services.

The base innovation platform community includes mechanisms and frameworks to secure sizable community so that a network effect for accelerated adoption and hyper-growth of community, data/metadata, and services can take place. The enabling mechanisms and framework include application, data and services that provide high utility and in some cases allow the utility to increase significantly with additional user, data, or services to form a benign cycle of: community generated content; and content attracting more community.

The framework for transforming the traditional solution to a problem into a new solution at scale should include refactoring, aggregation and a leveraged large scale linchpin dataset (e.g., that might have been previously generated manually or is generated or supplemented as needed in accordance with the present principles). This framework enables leveraging the composing of a new solution from the best of in class solutions or solution components that were solved previously under many different circumstances manually or automatically.

The platform for comprehensive continuous monitoring, model-based data assimilation, and what-if scenario simulation can offer continuous monitoring of the consumption of composed services (by the end users), and the adoption of these services for composing other services (by developers). The data from the monitoring can be assimilated into a model that can be used to conduct what-if analysis of the user and developer communities.

The proactive platform enhancement and optimization at scale can be based on the evolution of the needs of either the end user or developers, where innovative new services and/or incremental improvements on existing services are being made to the services provided. These suggestions for new services or enhancements of existing services are based on the what-if analysis from the models described herein below. This can support an even greater number of users, developers and value added service providers and allow them to extract additional utilities from the innovation platform environment/ecosystem.

Several definitions will now be given. Base services refer to services that are independent (orthogonal) with respect to each other, are consumable, and can serve as the basis to form combinations of services. Innovation community refers to a community that includes service providers, users, developers, and any other group that can contribute to the consumption and/or furtherance of an innovation. Furtherance can be achieved by development, use in a product or service, and so forth.

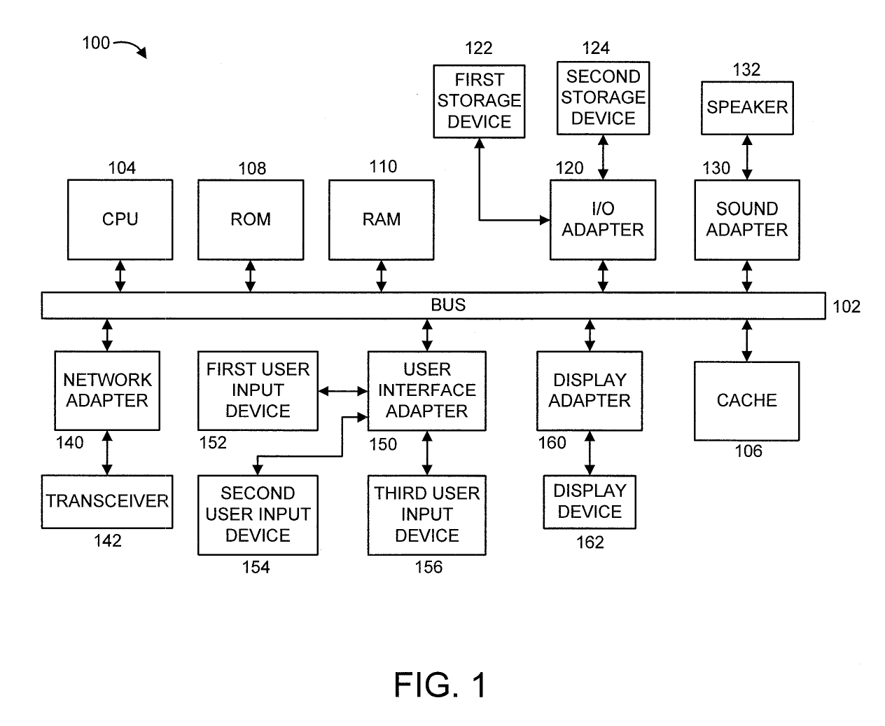

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

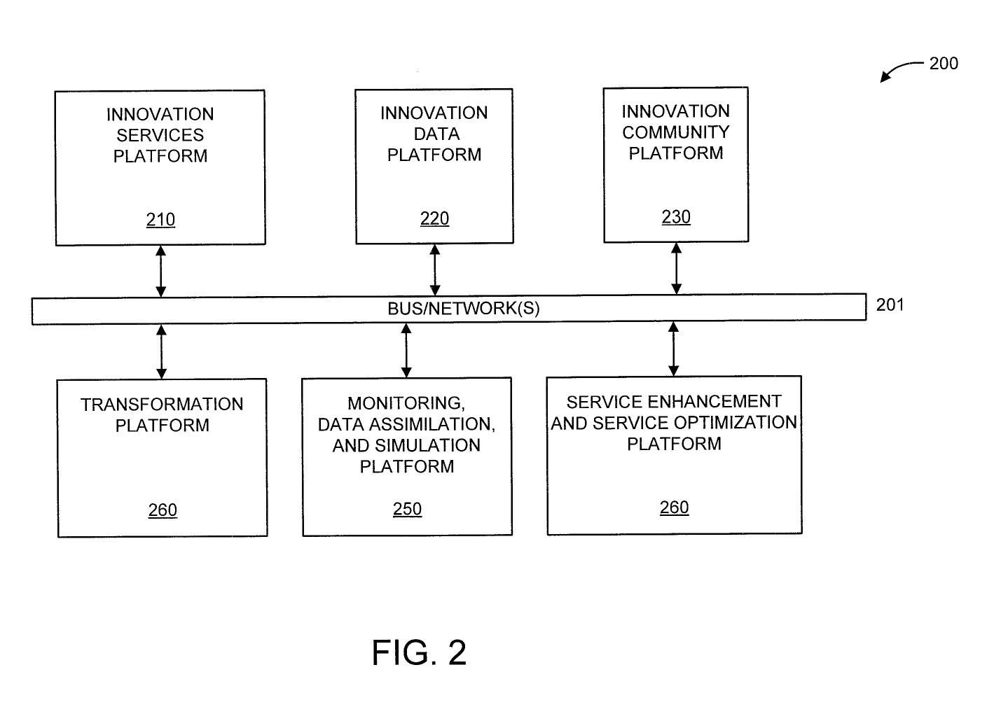

Moreover, it is to be appreciated that system 200 described below with respect to FIG. 2 is a system for implementing respective embodiments of the present principles. Part or all of processing system 100 may be implemented in one or more of the elements of system 200.

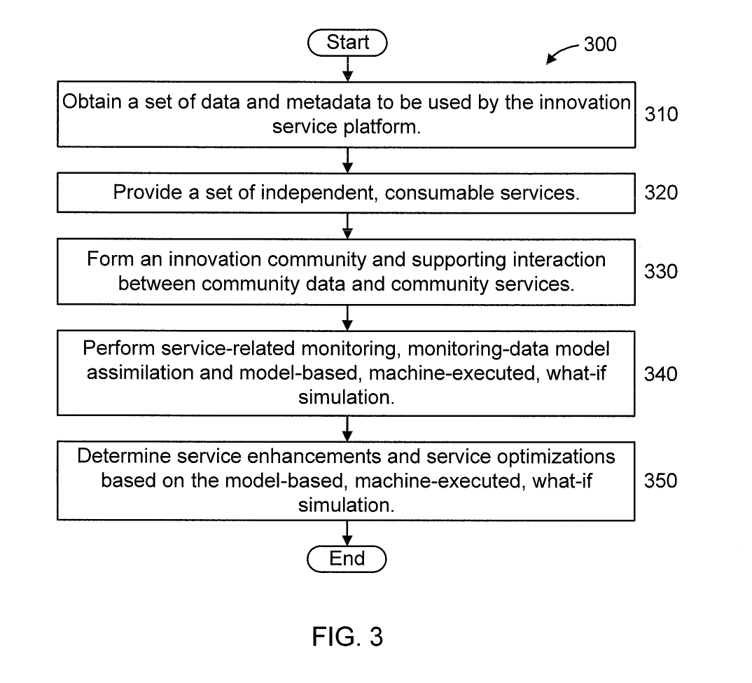

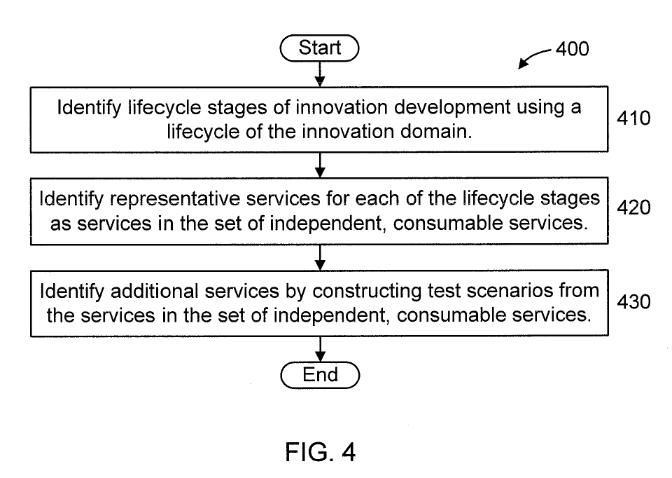

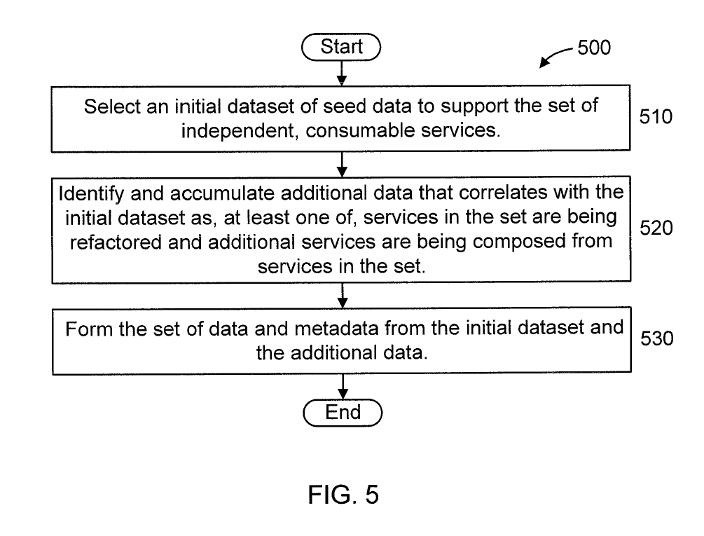

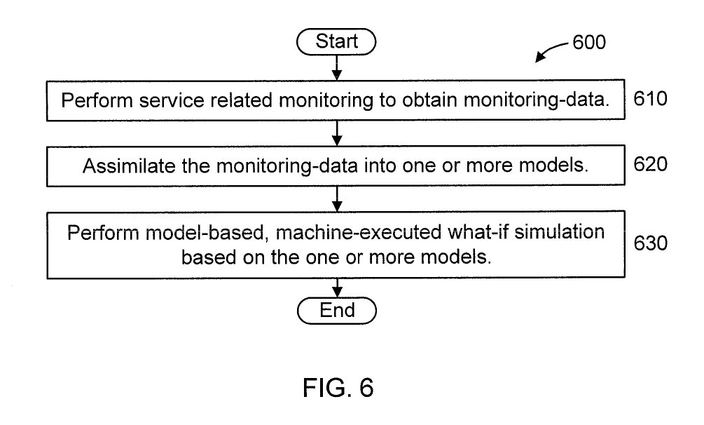

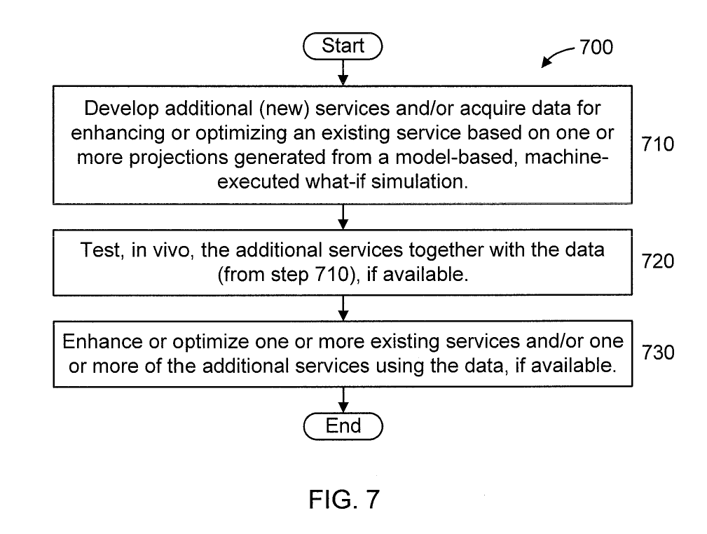

Further, it is to be appreciated that processing system 100 may perform at least part of the method described herein including, for example, at least part of method 300 of FIG. 3 and/or at least part of method 400 of FIG. 4 and/or at least part of method 500 of FIG. 5 and/or at least part of method 600 of FIG. 6 and/or at least part of method 700 of FIG. 7. Similarly, part or all of system 200 may be used to perform at least part of method 300 of FIG. 3 and/or at least part of method 400 of FIG. 4 and/or at least part of method 500 of FIG. 5 and/or at least part of method 600 of FIG. 6 and/or at least part of method 700 of FIG. 7.

FIG. 2 shows an exemplary system 200 for creating sustainable innovation platforms based on a service first and service now approach, in accordance with an embodiment of the present principles.

The system 200 includes an innovation services platform 210, an innovation data platform 220, an innovation community platform 230, a transformation platform 240, a monitoring, data assimilation, and simulation platform 250, and a service enhancement and service optimization platform 260.

The innovation services platform 210 includes a set of independent, consumable services.

The innovation data platform 220 includes a set of data and metadata used by the innovation service platform 210.

The innovation community platform 230 includes a set of frameworks for forming an innovation community and supporting interaction between community data and community services.

The transformation platform 240 transforms a traditional solution to a problem into a new solution.

The monitoring, data assimilation, and simulation platform 250 performs service-related monitoring, monitoring-data model assimilation and model-based, machine-executed, what-if simulation.

The service enhancement and service optimization platform 260 determines service enhancements and service optimizations based on the model-based, machine-executed, what-if simulation.

The various elements 210 through 260 of system 200 are further described herein in accordance with one or more embodiments of the present principles.

In the embodiment shown in FIG. 2, the elements thereof are interconnected by a bus 201/network(s). However, in other embodiments, other types of connections can also be used. Moreover, in an embodiment, at least one of the elements of system 200 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. Moreover, one or more elements of system 200 may be incorporated in a distributed fashion in one or more separate devices including separate servers and the like. For example, different elements/platforms can be located at different locations. Further, one or more of these elements/platforms can involve one or more datacenters. Additionally, one or more of these elements/platforms can involve one or more of infrastructure services, information management services, composition services, middleware, corresponding applications, and so forth as readily appreciated by one of ordinary skill in the art, given the teachings of the present principles provided herein. Also, more than one instance of any of the elements/platforms can be used in an embodiment of the present principles. Moreover, system 200 can be implemented using cloud technology and configurations as described herein. These and other variations of the elements of system 200 are readily determined by one of ordinary skill in the art, given the teachings of the present principles provided herein, while maintaining the spirit of the present principles.

FIG. 3 shows an exemplary method 300 for creating sustainable innovation platforms based on a service first and service now approach, in accordance with an embodiment of the present principles.

At step 310, obtain, by the innovation data platform, a set of data and metadata to be used by the innovation service platform.

At step 320, provide, by the innovation services platform, a set of independent, consumable services.

At step 330, form, by the innovation community platform including a set of frameworks, an innovation community and supporting interaction between community data and community services.

At step 340, perform, by the monitoring, data assimilation, and simulation platform, service-related monitoring, monitoring-data model assimilation and model-based, machine-executed, what-if simulation.

At step 350, determine, by the service enhancement and service optimization platform, service enhancements and service optimizations based on the model-based, machine-executed, what-if simulation.

FIG. 4 shows a method 400 for identifying a set of independent, consumable services and additional services, in accordance with an embodiment of the present principles.

At step 410, identify lifecycle stages of innovation development using a lifecycle of the innovation domain.

At step 420, identify representative services for each of the lifecycle stages as services in the set of independent, consumable services.

At step 430, identify additional services by constructing test scenarios from the services in the set of independent, consumable services.

FIG. 5 shows a method 500 for obtaining a set of data and metadata used by the innovation service platform 210, in accordance with an embodiment of the present principles.

At step 510, select an initial dataset of seed data to support the set of independent, consumable services.

At step 520, identify and accumulate additional data that correlates with the initial dataset as, at least one of, services in the set are being refactored and additional services are being composed from services in the set.

At step 530, form the set of data and metadata from the initial dataset and the additional data.

FIG. 6 shows a method 600 for performing service-related monitoring, monitoring-data model assimilation, and model-based, machine-executed what-if simulation, in accordance with an embodiment of the present principles.

At step 610, perform service related monitoring to obtain monitoring-data. The service related monitoring can include, for example, monitoring end-user service consumption and developer service adoption for other service composition.

At step 620, assimilate the monitoring-data into one or more models. In an embodiment, step 620 can involve filtering the data. As is readily appreciated by one of ordinary skill in the art, the type of filtering is dependent upon the specific implementation.

At step 630, perform model-based, machine-executed what-if simulation based on the one or more models. In an embodiment, step 630 can involve performing one or more simulations. In an embodiment, step 630 can involve generating one or more projections.

FIG. 7 shows a method 700 for service enhancement and service optimization, in accordance with an embodiment of the present principles.

At step 710, develop additional (new) services and/or acquire data for enhancing or optimizing an existing service based on one or more projections generated from a model-based, machine-executed what-if simulation (such as that generated by step 630 if FIG. 6).

At step 720, test, in vivo, the additional services together with the data (from step 710), if available.

At step 730, enhance or optimize one or more existing services and/or one or more of the additional services using the data, if available.

Consumption of IT is moving away from hardware and software products to capabilities delivered through services.

The evolutions of infrastructure for both enterprise and cloud service providers are quite different as compared to the past. We note the following two key observations that relate to Service First and Service Now.

Regarding Service First, innovation is being developed/applied at the point of consumption. Traditionally, innovation is developed mostly in an isolated environment (e.g., a laboratory) before it is deployed and consumed as a product. The cycle from the initial concept definition to the time of consumption can be potentially very lengthy, and often takes months or even years. The trend towards Service First enables the innovation to be consumed much earlier (as a service).

Regarding Service Now, the innovation is evolved in vivo (as opposed to in vitro) continuously and incrementally in response to demand. Using Netflix as an example, the display of the selection of movies in terms of taxonomy (or categories) and the relative ranking within each category are continuously learned and adapted based on its interactions with the user, whether the user actually drills into any of the movie selections, how long they watch, which device they watch on and where they watch. The infrastructure supporting the rapid growth of the users (more than 37 times between 2010 and 2011) also quickly evolve during the growth of Netflix, including the use of Content Distribution Network (Akamai), Hadoop and Hive, NoSQL databases such as Cassandra. The key is the evolution needs to happen in a live environment, so that both the learning of what happened and the application of an adjustment can happen in the live environment as soon as possible. Traditionally, the learning might happen in a sandbox using “traces” captured from the previous execution to emulate. However, the traditional approach will never be able to learn the impact of the changes in real time.

We now describe differences between a traditional Product First, i.e., waterfall, approach versus the Service First, iterative in vivo refinement approach. In the traditional Product First approach, an innovation is developed based on the projected needs at the time of introducing the product. However, it is very likely that the actual needs (of the market have already shifted by the time the innovation is introduced to the market, resulting in missing the actual needs of the market. Alternatively, the Service First approach experiments and evolves new capabilities in the form of services with much smaller incremental innovation within the marketplace directly so that the evolution of the innovation closely track the actual evolution of the market needs. The Service First approach substantially reduces the risks of moving into a space that is totally out of step with the expectation and actual evolution of the market.

Innovation at the point of consumption in the Service First, Service Now environment can happen at all levels—process level, service level and infrastructure levels, where the new capabilities are built on top of other capabilities within the platform. In all cases, successful platforms usually had linchpin and attractive content (in the form of consumable services or consumable data/metadata) to attract user and developer communities, which can contribute additional content. This positive feedback loop can ensure a sustainable ecosystem. Those platforms that do not reach a sustainable state will have a shrinking community, resulting in shrinking content and their ultimate demise.

In the following, we will use three examples (as shown below) to illustrate the notion of establishing successful open service and linchpin/pivotal data.

In the first example, as of Dec. 27, 2013, the Google® Maps application programming interface (API), which allow for the embedding of Google Maps onto web pages of outside developers, designed to work on both mobile devices as well as traditional desktop browser applications, is the most widely used API according to programmableweb.com. It is being used by 39% (or 2528 out of the total 10674) of the registered APIs or mashups on programmable web. The popularity of Google Maps came from the pivotal (or linchpin) data, namely the GIS data of the entire world, and the efficient map services built on top of it. This is in contrast to the traditional GIS software.

In the second example, Facebook's API has also been a widely reused by many other mashups (412 as of Dec. 27, 2013). The primary attraction of Facebook® is its pivotal data in capturing both the structural and temporal relationships among people. As a matter of fact, the momentum was so huge that other social media outlets had difficulties in gaining sufficient traction momentum.

In the third example, system z developed a very strong ecosystem since its introduction to the marketplace in 1964, especially for transactional data. A strong set of middleware services such as Information Management System (IMS), Customer Information Control Systems (CICS), and Transaction Processing Facility (TPF) have become widely deployed as the substrate for airline reservation systems, core banking systems, and utility company customer relationship management systems.

In each of these cases, there is an anchored innovation “platform” (Google map Application Programming Interface (API), Facebook API, and IMS/CICS/TPF on top of system z) which provided both open service and pivotal data, an ever expanding user and developer community, and a positive feedback loop between the accumulated content (consumable services and data) and the expansion of the ecosystems. Each anchored innovation platform always has an anchored service provider behind it, namely Google®, Facebook®, and IBM® for the three examples we discussed.

Thus, a successful Ecosystem often includes an anchored innovation platform and pivotal data, processes and services. The development of innovation platforms during the past two decades (since 2000) has always started in the consumer space, and then propagated to the enterprise space. This phenomenon is also known as enterpritization of consumer IT. Historically, the evolution of the innovation platforms, up to now, includes the following: digitization of transaction; digitization of enterprise; and digitization of industry.

Regarding digitization of transaction, the commencement of the Internet era also triggered the beginning of digitizing transactions and e-commerce in the context of business-to-customer (B2C) and subsequently business-to-business (B2B). The broad adoption of e-commerce enables key players such as Amazon® and EBay® to capture substantial amount of user purchase behavior which, in turn, allows the platform to have more intelligent interactions (such as projecting future needs) with the user, resulting in continuous improvement of user experience.

Regarding digitization of enterprise, since 2000, platforms were created for digitization of the entire enterprise, including the rapid adoption of business process management (BPM) and information integration platforms to orchestrate the business processes and data transformation and migration across organizations. Many of the traditional enterprise applications such as Enterprise Resource Planning, Customer Relationship Management (CRM), Supplier Relationship Management (SRM), and Intelligent Case Management were refactored to be based on these platforms so that these applications can be tied more directly with different pieces of the business within the enterprise. Through the BPM and information integration platforms, business behavior patterns (in terms of process and data orchestration) can be captured and benchmark against best practice, resulting in continuous improvement and optimization of the business.

Regarding digitization of industry, in the foreseeable future, the innovation platforms will start focusing on digitization of the industry ecosystem. The key to the success of platforms for digitization of industry is likely to be the ability to capture and continuous improve the behavior across the industry participants.

A further description of the following will now be given: base innovation platform services; base innovation platform data; a platform for comprehensive continuous monitoring, model-based data assimilation, and what-if scenario simulation; and proactive platform enhancement.

Further regarding the base innovation platform services, the Google® Maps JavaScript® API (https://developers.google.com/maps/documentation/javascript/) can be used as an example to illustrate the base innovation platform services, which include controls, overlays, Eigenservices (e.g., geocoder, directions, distance, duration), map types, layers, street view, evens, base, multi-view coding (MVC), geometry library, adsense library, Panoramio Library, places library, drawing library, weather library, visualization library). Both Yahoo® Maps and MapQuest® are providing similar APIs subsequently as alternatives for map application developers. In order to identify the base innovation platform services for each new domain, in an embodiment, the methodology can include the following:

1. Use lifecycle (inception, development, deployment, continuous operation, enhancement and renewal) of the innovation domain to identify stages of the innovation development.

2. Identify the representative services for each stage of the lifecycle. These “representative” services are the “seed” services (whether this is for map services, genomic sequencing, translational medicine, syndromic surveillance, Internet of Things, and so forth).

3. New set of services are identified through constructing “test scenarios” from these “seed” services. These new seed services could be decomposed and/or refactored from existing services. The set of services become the Eigen-services when the set of services stabilized when constructing new services.

Further regarding the base innovation platform data, as noted above, the same includes a set of linchpin data and metadata that are needed by the base platform services, including the “patterns” for composing and configuring the services. The linchpin data can be used to bootstrap the services composed from the Eigenvector services. In an embodiment, the methodology for building up the linchpin data can include the following:

1. Select initial “seed” data that is sufficient to support all of the Eigen-services. We note the following examples. In the case of map services, the linchpin data is the basic GIS related data for the world. In the case of the Internet of Things (IoT), the linchpin data is the behavior data of the specific domain such as, for example, the city traffic, the smart grid, and so forth. In the case of syndromic surveillance, the linchpin data is the health insurance claim data that include the diagnostic code for the patients. The preceding are merely illustrative examples and the particular initial seed data that is selected depends upon the implementation.

2. Identify and accumulate additional data that partially or fully correlates with the initial dataset as services are being refactored and new services are being composed from existing services.

The data should contribute to capture the “behavior” or “patterns” of the services being provided. This stage is a significant enhancement, where non-obvious and nontraditional data/metadata are identified to provide differentiated services. In the case of syndromic surveillance, this data could include over-the-counter (OTC) drug sales data from supermarket to enable prediction of upcoming flu outbreak.

3. Additional data can be accumulated during the process of community participation.

Further regarding the platform for comprehensive continuous monitoring, model-based data assimilation, and what-if scenario simulation, this platform can offer continuous monitoring of the consumption of composed services (by the end users), and the adoption of these services for composing other services (by developers). The data from the monitoring can be used to assimilated into a model that can be used to conduct what-if analysis of the user and developer communities and, in an embodiment, can include the following:

1. The key aspect of the disclosed innovation platform is the framework and mechanisms for either specifying the behavior models of the services being provided initially or autonomically capturing the behavior models subsequently.

2. Data collected by the innovation platform is assimilated to the behavior model, which also filter and/or cleanse the data.

3. The model is then used to conduct what-if analysis to project potential future paths of the customer behavior, future needs of services, and future needs of data.

Further regarding proactive platform enhancement, based on the evolution of the needs of either the end user or developers, innovative new services and/or incremental improvement on existing services are being made to the services provided. These suggestions for new services or enhancement of existing services are based on the what-if analysis from the models developed in preceding item 3. In an embodiment, the proactive platform enhancement can include the following:

1. The projection produced in item 3 under the platform for comprehensive monitoring, model-based data assimilation, and what-if scenario simulation will be used as the basis for developing new services and/or acquiring data

2. Newly developed services will be tested in vivo together with the data.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

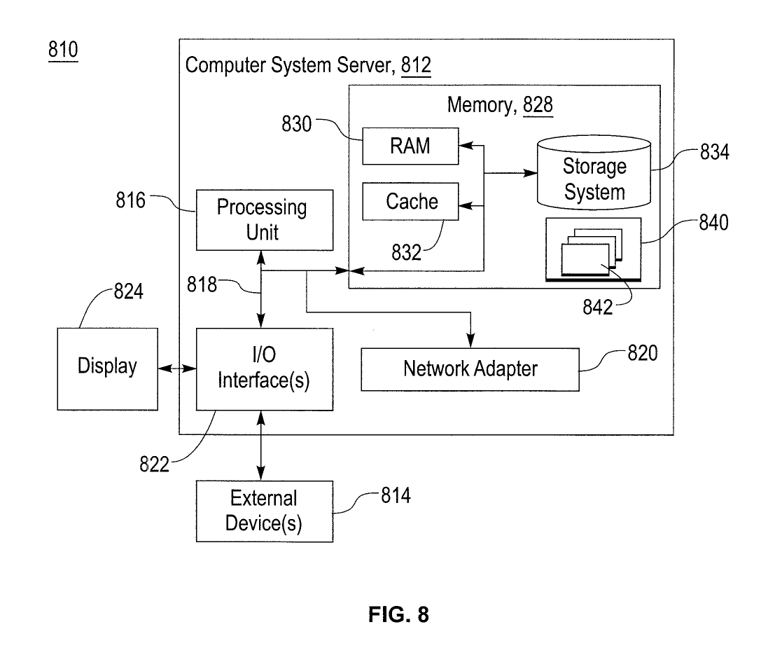

Referring now to FIG. 8, a schematic of an example of a cloud computing node 810 is shown. Cloud computing node 810 is only one example of a suitable cloud computing node and is not intended to suggest any limitation as to the scope of use or functionality of embodiments of the invention described herein. Regardless, cloud computing node 810 is capable of being implemented and/or performing any of the functionality set forth hereinabove.

In cloud computing node 810 there is a computer system/server 812, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 812 may be described in the general context of computer system executable instructions, such as program modules, being executed by a computer system. Generally, program modules may include routines, programs, objects, components, logic, data structures, and so on that perform particular tasks or implement particular abstract data types. Computer system/server 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 812 in cloud computing node 810 is shown in the form of a general-purpose computing device. The components of computer system/server 812 may include, but are not limited to, one or more processors or processing units 816, a system memory 828, and a bus 818 that couples various system components including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 812 typically includes a variety of computer system readable media. Such media may be any available media that is accessible by computer system/server 812, and it includes both volatile and non-volatile media, removable and non-removable media.

System memory 828 can include computer system readable media in the form of volatile memory, such as random access memory (RAM) 830 and/or cache memory 832. Computer system/server 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions of embodiments of the invention.

Program/utility 840, having a set (at least one) of program modules 842, may be stored in memory 828 by way of example, and not limitation, as well as an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the invention as described herein.

Computer system/server 812 may also communicate with one or more external devices 814 such as a keyboard, a pointing device, a display 824, etc.; one or more devices that enable a user to interact with computer system/server 812; and/or any devices (e.g., network card, modem, etc.) that enable computer system/server 812 to communicate with one or more other computing devices. Such communication can occur via Input/Output (I/O) interfaces 822. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples, include, but are not limited to: microcode, device drivers, redundant processing units, external disk drive arrays, RAID systems, tape drives, and data archival storage systems, etc.

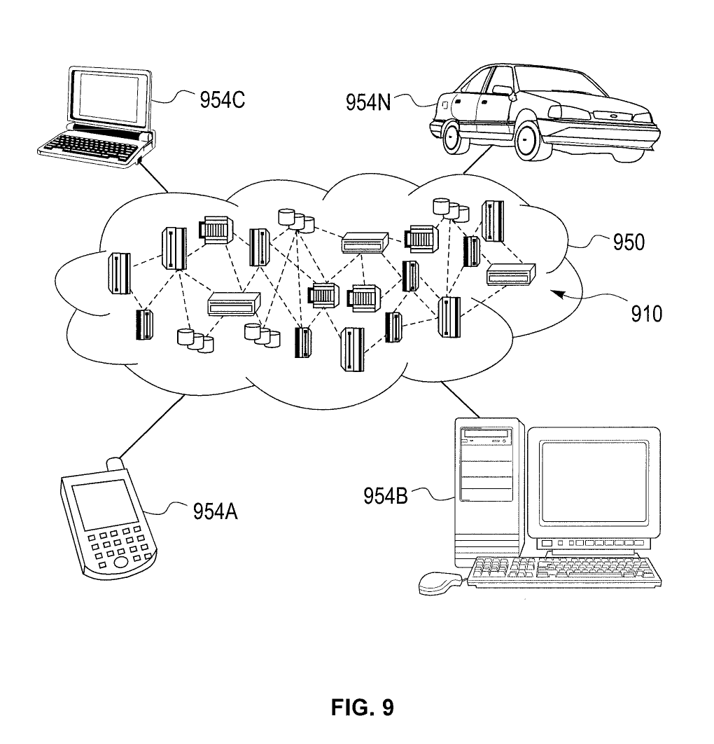

Referring now to FIG. 9, illustrative cloud computing environment 950 is depicted. As shown, cloud computing environment 950 comprises one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

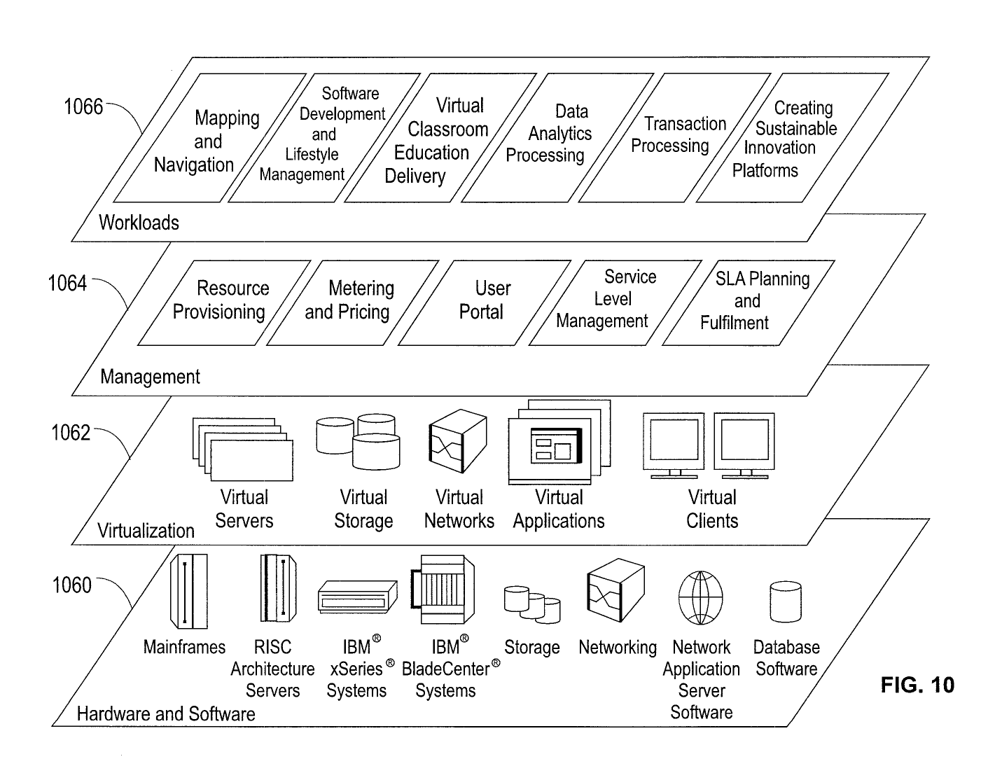

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1062 provides an abstraction layer from which the following examples of virtual entities may be provided: virtual servers; virtual storage; virtual networks, including virtual private networks; virtual applications and operating systems; and virtual clients.

In one example, management layer 1064 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1066 provides examples of functionality for which the cloud computing environment may be utilized. Examples of workloads and functions which may be provided from this layer include: mapping and navigation; software development and lifecycle management; virtual classroom education delivery; data analytics processing; transaction processing; and creating sustainable innovation platforms based on service first and service now approach.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for establishing a sustainable innovation platform, comprising:
providing, by an innovation services platform, a set of independent, consumable services;
forming, by an innovation community platform including a set of frameworks, an innovation community and supporting interaction between community data and community services;
performing, by a monitoring, data assimilation, and simulation platform, service-related monitoring, monitoring-data model assimilation and model-based, machine-executed, what-if simulation; and
determining, by a service enhancement and service optimization platform, service enhancements and service optimizations based on the model-based, machine-executed, what-if simulation.

2. The method of claim 1, wherein said performing step monitors end-user service consumption and developer service adoption for other service composition.

3. The method of claim 2, wherein the innovation community comprises an end-user community and a developer community, wherein monitoring data is assimilated into at least one model, and wherein what-if analysis of the end-user community and the developer community is performed based on the at least one model.

4. The method of claim 1, wherein the model-based, machine-executed what-if simulation predicts potential future paths of at least one of customer behavior, service demand, service requirements, and service-related data requirements
